(19) United States
(12) Patent Application Publication
(10) Pub. No.: US 2020/0062057 A1
(43) Pub. Date: Feb. 27, 2020

(54) BALL AND SOCKET ASSEMBLY WITH CLIP RETENTION SYSTEM

(71) Applicant: GM GLOBAL TECHNOLOGY OPERATIONS LLC, Detroit, MI (US)

(72) Inventors: Jason Zink, Rochester Hills, MI (US); Himanshu H. Mehta, Ann Arbor (US)

(21) Appl. No.: 16/106,213

(22) Filed: Aug. 21, 2018

(51) Int. Cl. B60D 1/06; B60D 1/58; B60D 1/60

(52) U.S. Cl. CPC B60D 1/06; E05B 57/00; B60D 1/60; B60D 1/583

(57) ABSTRACT

An exemplary embodiment of a locking clip for a ball and socket assembly includes a socket engagement portion, a positioning tab extending from a first end of the socket engagement portion, an first retention portion having an outer surface and a first engagement surface opposite the outer surface, the first retention portion coupled to the socket engagement portion; and a second retention portion having a second engagement surface, a second surface opposite the second engagement surface, and a release tab extending from a first end of the second retention portion opposite a second end of the second retention portion proximal to the positioning tab, the second retention portion flexibly coupled to the socket engagement portion. The first retention portion and the second retention portion are flexibly coupled to the socket engagement portion and the first and second engagement surfaces define a clip retention area.

### INTRODUCTION

The present invention relates generally to the field of vehicles and, more specifically, to a clip assembly for a ball and socket joint, including a locking clip.

Struts used for closure counterbalance typically use a single spring clip for retention of the ball stud within the socket. Failure of the single spring clip can result in disengagement of the ball stud from the socket.

### SUMMARY

Embodiments according to the present disclosure provide a number of advantages. For example, embodiments according to the present disclosure provide a secondary safety or locking clip that provides a locking feature to ensure full engagement of the ball stud within the socket.

In one aspect, a ball and socket assembly includes a socket including a main body including a clip engagement area and a socket edge formed in the main body, the socket edge defining a socket cavity, a ball stud including a ball configured to engage the socket cavity, a first clip configured to secure the ball within the socket cavity, the first clip including an outer surface and an inner surface, the first clip movable from an engaged position to a disengaged position, and a second clip configured to translate from a first position to a second position within the clip engagement area of the socket, the second clip including a socket engagement portion, an first retention portion having a first engagement surface, and a second retention portion having a second engagement surface, the first and second engagement surfaces defining a clip retention area, a socket engagement portion, and a positioning tab. The first retention portion and the second retention portion are flexibly coupled to the socket engagement portion and the first and second engagement surfaces engage and retain at least a portion of the first clip within the clip retention area.

In some aspects, the second retention portion of the second clip further includes a release tab extending in a direction opposite from the second engagement surface, wherein translation of the second clip within the clip engagement area rotates the second retention portion of the second clip relative to the socket engagement portion.

In some aspects, the second engagement surface of the second clip acts on the inner surface of the first clip such that rotation of the second retention portion lifts the first clip away from the socket such that the first clip moves from the engaged position to the disengage position.

In some aspects, the first engagement surface of the second clip acts on the outer surface of the first clip and the second engagement surface acts on the inner surface of the first clip to frictionally engage the first clip and the second clip.

In some aspects, the clip engagement area of the socket includes a plurality of surfaces formed in the socket such that translation of the second clip along the plurality of surfaces moves the second retention portion relative to the socket engagement portion.

In some aspects, the clip engagement area of the socket includes an inclined surface and translation of the release tab along the inclined surface rotates the second retention portion of the second clip relative to the socket engagement portion.

In some aspects, the clip engagement area of the socket includes a plurality of stop surfaces configured to interact with the second clip to restrict lateral movement of the second clip within the clip engagement area.

In some aspects, the first position of the second clip is an insertion position and the second position is a retention position, wherein in the second position the second clip secures the first clip to the socket.

In some aspects, the second clip further includes a positioning tab flexibly coupled to the socket engagement portion, the positioning tab extending away from the socket and including a gripping surface.

In another aspect, a locking clip for a ball and socket assembly includes a socket engagement portion, a positioning tab extending from a first end of the socket engagement portion, an first retention portion having an outer surface and a first engagement surface opposite the outer surface, the first retention portion coupled to the socket engagement portion, and a second retention portion having a second engagement surface, a second surface opposite the second engagement surface, and a release tab extending from a first end of the second retention portion opposite a second end of the second retention portion proximal to the positioning tab, the second retention portion flexibly coupled to the socket engagement portion. The first retention portion and the second retention portion are flexibly coupled to the socket engagement portion and the first and second engagement surfaces define a clip retention area.

In some aspects, the positioning tab includes a gripping surface and the positioning tab extends vertically away from the socket engagement portion.

In yet another aspect, a clip assembly to secure a ball and socket assembly includes a first clip including an outer surface and an inner surface, and a second clip including a first retention portion having a first engagement surface, a second retention portion having a second engagement surface, the first and second engagement surfaces defining a clip retention area, a socket engagement portion, and a positioning tab. The first retention portion and the second retention portion are flexibly coupled to the socket engagement portion and the first and second engagement surfaces engage and retain at least a portion of the first clip within the clip retention area.

In some aspects, the positioning tab of the second clip includes a gripping surface and the positioning tab extends vertically away from the socket engagement portion.

In some aspects, the second retention portion of the second clip further includes a release tab extending in a direction opposite from the second engagement surface, wherein translation of the second clip with respect to the ball and socket assembly rotates the second retention portion of the second clip relative to the socket engagement portion.

In some aspects, the second engagement surface acts on the inner surface of the first clip such that rotation of the second retention portion lifts the first clip.

In some aspects, the first engagement surface of the second clip acts on the outer surface of the first clip and the second engagement surface acts on the inner surface of the first clip to frictionally engage the first clip and the second clip.

### BRIEF DESCRIPTION OF THE DRAWINGS

The present disclosure will be described in conjunction with the following figures, wherein like numerals denote like elements.

FIG. 1 is a perspective view of a ball and socket assembly with a clip restraint system, according to an embodiment.

FIG. 2 is cutaway side view of the socket of the ball and socket assembly shown in FIG. 1.

FIG. 3 is a side view of the clip restraint system of FIG. 1.

FIG. 4 is a side view of the clip restraint system of FIG. 1 with the locking clip in one position, according to an embodiment.

FIG. 5 is a side view of the clip restraint system of FIG. 1 with the locking clip in another position, according to an embodiment.

FIG. 6 is a side view of the clip restraint system of FIG. 1 with the locking clip in yet another position, according to an embodiment.

FIG. 7 is a side view of the clip restraint system of FIG. 1 with the locking clip in yet another position, according to an embodiment.

FIG. 8 is a side view of the clip restraint system of FIG. 1 with the locking clip in yet another position, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to Which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

Struts used for closure counterbalance typically rely on a single spring clip for retention of the strut socket to a ball stud. Embodiments discussed herein provide a secondary locking clip that enables proper seating position of the spring clip on the socket for more reliable retention of the ball stud within the socket of the strut.

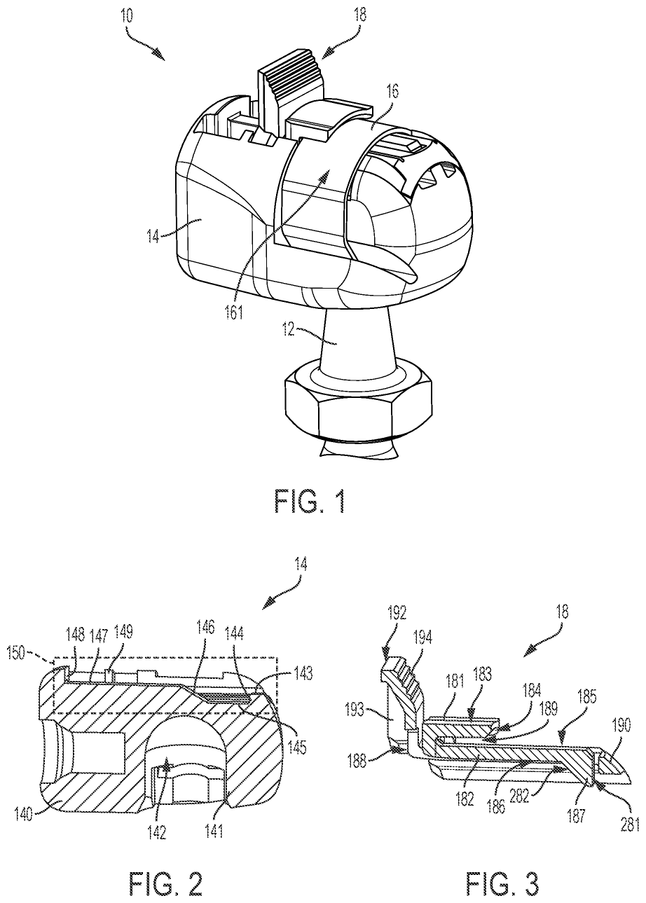

FIG. 1 illustrates a ball and socket assembly 10 that is used, in some embodiments, for connection of a ball stud 12 to a strut head or socket 14. The assembly 10 also includes a spring clip 16 and a locking clip 18. The spring clip 16 is a generally curved, semicircular member that engages the ball of the ball stud 12 to secure the ball within a cavity of the strut socket 14. In various embodiments, the spring clip 16 has an outer surface 161 and an inner surface 162. However, the spring clip 16 may disengage from the strut socket 14, allowing the ball stud 12 to lose engagement with the socket 14. In various embodiments, the locking clip 18 engages the spring clip 16 to secure the spring clip 16 in an engaged position to retain the ball stud 12 more reliably within the strut socket 14.

With reference to FIG. 2, the strut head or socket 14 includes a main body 140. The main body 140 has an outer surface and a socket edge 141 formed in the main body 140. The socket edge 141 defines a socket cavity 142. The socket cavity 142 is configured to engage and retain the ball of the ball stud 12.

An upper portion of the main body 140 includes a locking clip engagement area 150. The locking clip engagement area 150 includes a plurality of surfaces formed in the main body 140 of the socket 14 that are configured to engage with the locking clip 18. A first stop surface 144 is generally perpendicular to an end surface 143. A first position adjustment surface 145 is contiguous with and generally perpendicular to the first stop surface 144. An inclined surface 146 is contiguous with the first position adjustment surface 145. A second position adjustment surface 147 is contiguous with the inclined surface 146. A second stop surface 148 is contiguous with and generally perpendicular to the second position adjustment surface 147. A stop member 149 is positioned between the first and second stop surfaces 144, 148. The stop member 149 interacts with the locking clip 18 to inhibit translation of the locking clip 18 from right to left (as viewed in FIGS. 1-8), when the locking clip 18 is in a retention position. The locking clip 18 is configured to slide or translate along the adjustment and inclined surfaces of the locking clip engagement area 150 as the locking clip 18 is inserted into the locking clip engagement area 150 and engages with the spring clip 16, as discussed in greater detail herein.

FIG. 3 illustrates the locking clip 18, according to an embodiment. The locking clip 18 includes an upper or first retention portion 181, a lower or second retention portion 182, a socket engagement portion 190, and a positioning tab 192. In general, the upper and lower retention portions 181, 182 engage and retain the spring clip 16 and the positioning tab 192 allows an installer to translate the locking clip 18 within the locking clip engagement area 150 of the socket 14 to position the locking clip 18 to selectively engage, retain, and release the spring clip 16, as discussed in greater detail below. In some embodiments, the locking clip 18 is unitarily formed from a rigid material, such as a moldable plastic.

The upper retention portion 181 and the lower retention portion 182 are flexibly coupled to and movable relative to the socket engagement portion 190. The upper and lower retention portions 181, 182 form a substantially U-shaped structure. In some embodiments, a length of the upper retention portion 181 is less than a length of the lower retention portion 182 in order to allow release of the spring clip 16 away from the socket 14 and the ball stud 12 as discussed below. However, the relative length between the upper retention portion 181 and the lower retention portion 182 does not affect the performance of the locking clip 18. In some embodiments, the locking clip 18 does not include a lower retention portion 182 and the spring clip 16 is retained between the upper retention portion 181 and the socket engagement portion 190.

The upper retention portion 181 includes an outer surface 183 and a clip engagement surface 184 opposite the outer surface 183. The clip engagement surface 184 can be arcuate in shape to conform to the curved outer surface 161 of the spring clip 16.

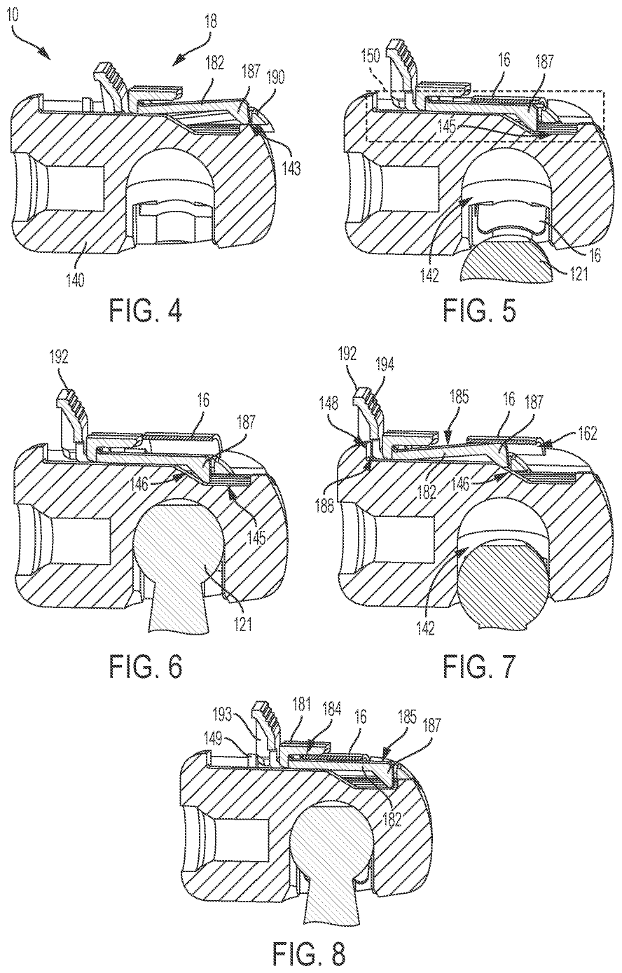

The lower retention portion 182 includes a clip engagement surface 185 and a second surface 186 opposite the clip engagement surface 185. A release tab 187 extends from a first end of the lower retention portion 182 opposite a second end of the lower retention portion 182 that is proximal to the positioning tab 192. The release tab 187 includes a first face 281 and a second face 282 oriented at an angle to the first face 281. The second face 282 is contiguous with the second surface 186 of the lower retention portion 182. The release tab 187 extends toward the socket 14. The lower retention portion 182 is flexibly coupled and movable relative to the socket engagement portion 190. As the release tab 187 translates along the surfaces of the locking clip engagement area 150, as discussed in greater detail herein, the lower retention portion 182 flexes away from the socket engagement portion 190 at an angle. This action is described in greater detail herein with reference to FIGS. 4-8. Additionally, the first face 281 interfaces with the first stop surface 144 to retain a position of the locking clip 18 relative to the socket 14, as discussed in greater detail with respect to FIGS. 4-8.

The clip engagement surface 184 of the upper retention portion 181 is opposite to the clip engagement surface 185 of the lower retention portion 182. Together, the clip engagement surfaces 184, 185 form a clip retention area 189. When the spring clip 16 is engaged with the locking clip 18, at least a portion of the spring clip 16 fits within the clip retention area 189 such that at least a portion of the spring clip 16 is sandwiched between the clip engagement surfaces 184, 185. When the spring clip 16 is retained by the locking clip in the retention position, at least a portion of the outer surface 161 of the spring clip 16 is adjacent to the clip engagement surface 184 and at least a portion of the inner surface 162 is adjacent to the clip engagement surface 185 (see FIGS. 7 and 8).

The positioning tab 192 is also flexibly coupled on one end to the socket engagement portion 190. The positioning tab 192 includes an end surface 188 configured to abut against the stop surface 148 of the socket 14. In some embodiments, the positioning tab 192 extends generally away from the socket 14 and includes a gripping surface 194. In some embodiments, the positioning tab 192 is generally vertical, however, the shape and orientation of the positioning tab 192 varies depending on the length and depth of the socket 14. In some embodiments, the gripping surface 194 is a serrated or roughened surface to facilitate easier manipulation by an installer. Pressure applied to the positioning tab 192 translates the locking clip 18 within the locking clip engagement area 150 of the socket 14 such that the locking clip 18 moves from a spring clip installation position, to a spring clip retention position, to a spring clip release position and vice versa, including various intermediate positions therebetween, as shown in FIGS. 4-8. The positioning tab 192 also includes a rear surface 193. As described herein, when the rear surface 193 contacts the stop member 149 restricts lateral movement or translation right to left (as viewed in FIGS. 4-8) of the locking clip 18.

In some embodiments, the size, shape, and configuration of the locking clip 18 is based on the size and shape of the socket 14 and the amount of lateral movement of the locking clip 18 allowed by the size and shape of the socket 14. For example, and without limitation, in some embodiments, the upper retention portion 181 acts on the spring clip 16 to retain the spring clip 16 against the socket engagement portion 190 (that is, the spring clip 16 is frictionally engaged between the upper retention portion 181 and the socket engagement portion 190 rather than the lower retention portion 182 of the locking clip 18). 00431 FIGS. 4-8 illustrate the locking clip 18 in various positions relative to the socket 14 and the spring clip 16. The locking clip 18 is illustrated throughout FIGS. 4-8 as the locking clip 18 is inserted from the right (FIG. 4), translated to the left (FIGS. 5-7), and translated to the right (FIG. 8). The terms “left” and “right” are used for convenience of viewing the figures and it is understood that movement of the locking clip 18 is longitudinal relative to the socket 14 within the locking clip engagement area 150 and is not limited to any specific direction.

FIG. 4 illustrates an insertion or installation position of the locking clip 18. In FIG. 4, the socket engagement portion 190 of the locking clip 18 is inserted into the locking clip engagement area 150 of the socket 14. The socket engagement portion 190 of the locking clip 18 slides into the insertion or installation position in the locking clip engagement area 150, with the end of the locking clip 18 including the positioning tab 192 inserted first. As the locking clip 18 translates longitudinally with respect to the socket 14, the release tab 187 of the lower retention portion 182 slides over the end surface 143. The release tab 187 lifts the lower retention portion 182 upward with respect to the socket engagement portion 190 of the locking clip 18.

After sliding over the end surface 143, the release tab 187 falls into the gap defined by the position adjustment surface 145, the first stop surface 144, and the inclined surface 146 as shown in FIG. 5. FIG. 5 illustrates the locking clip 18 in a spring clip 16 installation position. As the locking clip 18 slides further to the left within the locking clip engagement area 150, the release tab 187 slides along the first position adjustment surface 145 and the locking clip 18 moves into the spring clip 16 installation position. In the spring clip 16 installation position, the lower retention portion 182 is located further to the left as compared to when the locking clip 18 is in a spring clip 16 retention position (compare FIGS. 6 and 8) to allow the spring clip 16 to engage with the ball stud 12 and the socket 14. The position of the spring clip 16 and the locking clip 18 allow the ball 121 of the ball stud 12 to engage within the socket cavity 142.

As the locking clip 18 is slid further to the left via pressure applied to the positioning tab 192, the ball 121 is securely engaged within the socket cavity 142, as shown in FIG. 6. The spring clip 16 can be easily lifted to engage or disengage the ball 121 to ensure that the ball 121 is properly seated within the socket cavity 142.

With further leftward translation of the locking clip 18 within the locking clip engagement area 150 due to pressure applied to the positioning tab 192, as shown in FIG. 7, the release tab 187 slides up the inclined surface 146 such that the locking clip 18 is in a spring clip 16 release position. The inclined surface 146 acts as both a surface to lift and release the spring clip 16 and to provide resistance to movement of the locking clip 18 from the position shown in FIG. 6. As the release tab 187 slides up the inclined surface 146 due to additional pressure applied to the positioning tab 192, the lower retention portion 182 is angled upward with respect to the socket engagement portion 190. The clip engagement surface 185 of the lower retention portion 182 acts on the lower surface 162 of the spring clip 16, lifting the spring clip 16 from an engaged or installed position (as shown in FIG. 5, in which the spring 16 is configured to receive and retain the ball 121) to a disengaged or released position (as shown in FIG. 7). In the disengaged position, the spring clip 16 releases the ball 121 from the socket cavity 142. In the engaged position, the spring clip 16 securely engages the ball 121 within the socket cavity 142. The locking clip 18 travels longitudinally within the socket engagement area 150 until the end surface 188 abuts against the second stop surface 148 of the socket 14. In the configuration shown in FIG. 7, the locking clip 18 is in a spring clip 16 release position.

With reference to FIG. 8, the locking clip 18 is shown in a spring clip 16 retention position, having been slid to the right from the position shown in FIG. 7. In some embodiments, the stop member 149 restricts lateral movement or translation right to left (as viewed in FIGS. 4-8) of the locking clip 18 due to contact with the rear surface 193. In the spring clip 16 retention position, at least a portion of the spring clip 16 is sandwiched between the upper retention portion 181 and the lower retention portion 182. As shown in FIG. 8, the clip engagement surface 184 of the upper retention portion 181 is adjacent to and/or in contact with at least a portion of the curved outer surface 161 of the spring clip 16 and the clip engagement surface 185 of the lower retention portion 182 is adjacent to and/or in contact with the inner surface 162 of the spring clip 16. Friction and/or pressure between the clip engagement surface 184 and the outer surface 161 and/or between the first surface 185 and the inner surface 162 inhibit longitudinal movement of the locking clip 18. The locking clip 18 is restricted from further movement to the right when the first face 281 of the release tab 187 abuts against the first stop surface 144.

As discussed herein, the locking clip 18 is translatable from left to right or from right to left, as viewed in the FIGS. 4-8. Angled faces of the positioning tab 192 and the end surface 188 facilitate translation of the locking clip 18 within the clip engagement area 150. The angled faces allow the installer to apply less force to the positioning tab 192 to translate the locking clip 18 from the spring clip 16 installation position shown in FIG. 5 to the spring clip 16 retention position shown in FIG. 8. The stop member 149 restricts movement of the locking clip 18 from the retention position shown in FIG. 8 to the release position shown in FIG. 7. The installer applies pressure to the positioning tab 192 to overcome the resistance provided by the stop members, specifically the stop member 149, to translate the locking clip 18 between the retention position to the release position.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fail within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, hut that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A ball and socket assembly, comprising:
a socket comprising a main body including a clip engagement area and a socket edge formed in the main body, the socket edge defining a socket cavity;
a ball stud comprising a ball configured to engage the socket cavity;
a first clip configured to secure the ball within the socket cavity, the first clip comprising an outer surface and an inner surface, the first clip movable from an engaged position to a disengaged position; and
a second clip configured to translate from a first position to a second position within the clip engagement area of the socket, the second clip comprising a socket engagement portion, a first retention portion having a first engagement surface, and a second retention portion having a second engagement surface, the first and second engagement surfaces defining a clip retention area, a socket engagement portion, and a positioning tab;
wherein the first retention portion and the second retention portion are flexibly coupled to the socket engagement portion and the first and second engagement surfaces engage and retain at least a portion of the first clip within the clip retention area.

2. The ball and socket assembly of claim 1, wherein the second retention portion of the second clip further comprises a release tab extending in a direction opposite from the second engagement surface, wherein translation of the second clip within the clip engagement area rotates the second retention portion of the second clip relative to the socket engagement portion.

3. The ball and socket assembly of claim 2, wherein the second engagement surface of the second clip acts on the inner surface of the first clip such that rotation of the second retention portion lifts the first clip away from the socket such that the first clip moves from the engaged position to the disengage position.

4. The ball and socket assembly of claim 1, wherein the first engagement surface of the second clip acts on the outer surface of the first clip and the second engagement surface acts on the inner surface of the first clip to frictionally engage the first clip and the second clip.

5. The ball and socket assembly of claim 2, wherein the clip engagement area of the socket comprises a plurality of surfaces formed in the socket such that translation of the second clip along the plurality of surfaces moves the second retention portion relative to the socket engagement portion.

6. The ball and socket assembly of claim 5, wherein the clip engagement area of the socket comprises an inclined surface and translation of the release tab along the inclined surface rotates the second retention portion of the second clip relative to the socket engagement portion.

7. The ball and socket assembly of claim 5, wherein the clip engagement area of the socket comprises a plurality of stop surfaces configured to interact with the second clip to restrict lateral movement of the second clip within the clip engagement area.

8. The ball and socket assembly of claim 1, wherein the first position of the second clip is an insertion position and the second position is a retention position, wherein in the second position the second clip secures the first clip to the socket.

9. The ball and socket assembly of claim 1, wherein the second clip further comprises a positioning tab flexibly coupled to the socket engagement portion, the positioning tab extending away from the socket and including a gripping surface.

10. A locking clip for a ball and socket assembly, the locking clip comprising:
a socket engagement portion;
a positioning tab extending from a first end of the socket engagement portion;
a first retention portion having an outer surface and a first engagement surface opposite the outer surface, the first retention portion coupled to the socket engagement portion; and
a second retention portion having a second engagement surface, a second surface opposite the second engagement surface, and a release tab extending from a first end of the second retention portion opposite a second end of the second retention portion proximal to the positioning tab, the second retention portion flexibly coupled to the socket engagement portion;
wherein the first retention portion and the second retention portion are flexibly coupled to the socket engagement portion and the first and second engagement surfaces define a clip retention area.

11. The locking clip of claim 10, wherein the positioning tab comprises a gripping surface and the positioning tab extends vertically away from the socket engagement portion.

12. A clip assembly to secure a ball and socket assembly, the clip assembly comprising:
a first clip comprising an outer surface and an inner surface; and
a second clip comprising a first retention portion having a first engagement surface, a second retention portion having a second engagement surface, the first and second engagement surfaces defining a clip retention area, a socket engagement portion, and a positioning tab;
wherein the first retention portion and the second retention portion are flexibly coupled to the socket engagement portion and the first and second engagement surfaces engage and retain at least a portion of the first clip within the clip retention area.

13. The clip assembly of claim 12, wherein the positioning tab of the second clip comprises a gripping surface and the positioning tab extends vertically away from the socket engagement portion.

14. The clip assembly of claim 12, wherein the second retention portion of the second clip further comprises a release tab extending in a direction opposite from the second engagement surface, wherein translation of the second clip with respect to the ball and socket assembly rotates the second retention portion of the second clip relative to the socket engagement portion.

15. The clip assembly of claim 14, wherein the second engagement surface acts on the inner surface of the first clip such that rotation of the second retention portion lifts the first clip.

16. The clip assembly of claim 12, wherein the first engagement surface of the second clip acts on the outer surface of the first clip and the second engagement surface acts on the inner surface of the first clip to frictionally engage the first clip and the second clip.
